(19) United States
(12) Patent Application Publication
(10) Pub. No.: US 2009/0141666 A1
(43) Pub. Date: Jun. 4, 2009

(54) WIRELESS SENSOR NETWORK USING DYNAMIC MESSAGE ROUTING ALGORITHM AND METHOD OF CONTROLLING THE WIRELESS SENSOR NETWORK

(75) Inventors: Gwang Ja JIN, Daejeon-city (KR); Bong Soo KIM, Daejeon-city (KR); Cheol Sig PYO, Daejeon (KR); Jong Suk CHAE, Daejeon (KR); Young Ju HWANG, Seoul (KR); Dong Min KIM, Seoul (KR); Seong Lyun KIM, Seoul (KR)

Correspondence Address: STAAS & HALSEY LLP, SUITE 700, 1201 NEW YORK AVENUE, N.W., WASHINGTON, DC, 20005, US

(73) Assignees: ELECTRONICS AND TELECOMMUNICATIONS RESEARCH INSTITUTE, Daejeon (KR); INDUSTRY-ACADEMIC COOPERATION FOUNDATION, Seoul (KR)

(21) Appl. No.: 12/175,842

(22) Filed: Jul. 18, 2008

(30) Foreign Application Priority Data
Nov. 30, 2007 (KR) 10-2007-0123644

(51) Int. Cl. H04B 7/14

(52) U.S. Cl. 370/315

(57) ABSTRACT

Provided is a wireless sensor network using a dynamic message routing algorithm and a method of controlling the wireless sensor network. Therefore, a network system can be provided, in which each sensor node calculates a relay probability, periodically updates the relay probability, and dynamically determines a node for relaying a message on the basis of the relay probability, so that throughput per node is improved and a media access control (MAC) layer is not needed.

### CROSS-REFERENCE TO RELATED PATENT APPLICATION

This application claims the benefit of Korean Patent Application No. 10-2007-0123644, filed on Nov. 30, 2007, in the Korean Intellectual Property Office, the disclosure of which is incorporated herein in its entirety by reference.

### BACKGROUND OF THE INVENTION

1. Field of the Invention

The present invention relates to a network system including wireless sensor nodes, and more particularly, to a wireless sensor network system in which each node calculates and updates a relay probability for message transmission to dynamically route a message and a method of controlling the wireless sensor network system.

The present invention is derived from a research project supported by the Information Technology (IT) Research & Development (R&D) program of the Ministry of Information and Communication (MIC) and the Institute for Information Technology Advancement (IITA) [2005-S-038-03, Development of UHF RF-ID and Ubiquitous Networking Technology]

2. Description of the Related Art

A wireless sensor network includes a number of cooperating sensor nodes. Each sensor node is driven by a battery and includes a small-capacity memory and a processing device. Therefore, it is necessary to consider energy consumption, memory, and an operational efficiency for designing a communications protocol in the sensor network. Particularly, a routing protocol has to be light-weight and simple. In addition, since a node in the sensor network may disappear or brake down, self-configurability is required. When a fixed path includes a broken node, transmission fails and energy efficiency significantly decreases due to re-transmission through the broken path.

In order to deliver a message in the aforementioned wireless network, a multi-hop routing method is required. A representative routing method applicable to the wireless network is an ad hoc on-demand distance vector (AODV) algorithm based on a carrier sensing mechanism.

However, there are problems in that the conventional message routing method needs an additional media access controller (MAC) layer, and when a wireless node moves, throughput per node decreases.

### SUMMARY OF THE INVENTION

The present invention provides a network system in which each sensor node calculates a relay probability, periodically updates the relay probability, and dynamically determines a node for relaying a message on the basis of the relay probability, so that throughput per node is improved and a media access control (MAC) layer is not needed.

The present invention also provides a wireless sensor network in which loads are distributed and decreased.

The objects and advantages of the present invention will be explained in the following description, which includes exemplary embodiments of the present invention. In addition, it can be easily understood that the objects and advantages of the present invention can be implemented with means disclosed in the appended claims and combinations thereof.

According to an aspect of the present invention, there is provided a wireless sensor network including: a destination node broadcasting a beacon signal to nodes in a network; a transmission node transmitting a request-to-send message to neighboring nodes to select a relay node that relays a message to be transmitted to the destination node, receiving acknowledgement messages from the neighboring nodes which determine whether to transmit the acknowledgement messages on the basis of relay probabilities, and selecting the relay node on the basis of the acknowledgement messages; and a relay node receiving a beacon signal, measuring a strength of the beacon signal, transmitting an acknowledgement message including the strength of the beacon signal to the transmission node, and receiving the message from the transmission node.

According to another aspect of the present invention, there is provided a method of controlling a wireless sensor network including: a transmission node transmitting a request-to-send message to neighboring nodes in the network; each of the neighboring nodes determining whether or not to transmit an acknowledgement message on the basis of its own reliability and transmitting the acknowledgement message to the transmission node; the transmission node determining a node that is to relay data to be transmitted to the destination node from among the neighboring nodes that transmit the acknowledgement messages; the transmission node counting the number of the acknowledgement messages and determining a decrease or increase in the number of nodes in the network; and each of the transmission node and the neighboring nodes updating its own relay probability on the basis of the decrease or increase in the number of the nodes.

According to another aspect of the present invention, there is provided a computer-readable medium having embodied thereon a computer program for the method of controlling a wireless sensor network.

### BRIEF DESCRIPTION OF THE DRAWINGS

The above and other features and advantages of the present invention will become more apparent by describing in detail exemplary embodiments thereof with reference to the attached drawings in which:

FIG. 1 illustrates a wireless network including a number of nodes according to an embodiment of the present invention;

FIG. 2 is a view for explaining a message routing method of selecting a relay node in a wireless network according to another embodiment of the present invention;

FIG. 3 is a view for explaining a method of directly transmitting a packet to a destination node when a source node does not receive acknowledgement (ACK) signals from neighboring nodes that receive a request-to-send (RTS) signal according to another embodiment of the present invention;

FIG. 4 is a view for explaining a method of re-transmitting a packet when a source node does not receive an ACK signal from a destination node after transmitting a packet (referred to as a message) to the destination node according to another embodiment of the present invention;

FIG. 5 illustrates a packet structure in a wireless sensor network system applying a basketball routing algorithm according to another embodiment of the present invention;

FIG. 6 illustrates a message type of FIG. 5;

FIG. 7 illustrates a message loop that may occur when a message is transmitted using relay nodes according to another embodiment of the present invention;

FIG. 8 is a view for explaining a method of preventing a message loop according to another embodiment of the present invention;

FIGS. 9A to 9D are views for representing a topology of a network system according to another embodiment of the present invention;

FIG. 10 is a flowchart for explaining a method of updating a relay probability according to another embodiment of the present invention;

FIG. 11 is a graph illustrating the numbers of hops with respect to the number of nodes when the present invention and an ad hoc on-demand distance vector (AODV) routing are applied, respectively;

FIGS. 12A and 12B are views illustrating routing paths in a wireless network including twelve nodes applying the present invention and the ADOV routing, respectively;

FIG. 13 is a graph showing transmission distance per hop with respect to the number of nodes when the present invention and the AODV routing are applied to the wireless network; and

FIG. 14 is a graph showing a result of a test that was performed by using a method of updating a relay probability according to an embodiment of the present invention, and setting an initial value of the relay probability as being 25% and a variation range of the relay probability as being 5˜50%.

### DETAILED DESCRIPTION OF THE INVENTION

Hereinafter, exemplary embodiments of the present invention will be described in detail with reference to the attached drawings. Like reference numerals in the drawings denote like elements. In the description of the present invention, if it is determined that a detailed description of commonly-used technologies or structures related to the invention may unnecessarily obscure the subject matter of the invention, the detailed description will be omitted.

In addition, when a part “comprises” a component, it means that the part may further comprise other components but does not exclude other components unless specifically described.

According to the present invention, terms such as data, a packet, a data packet, a message, and a signal carry the same general meaning and are exchangeable.

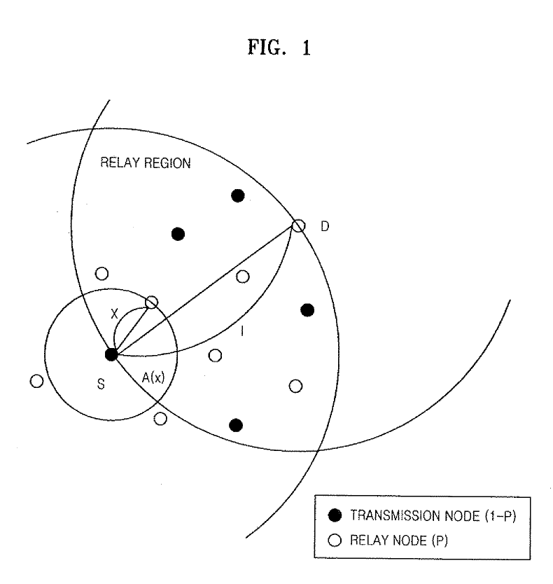

FIG. 1 illustrates a wireless network including a number of nodes according to an embodiment of the present invention.

Message routing through relay nodes according to the present invention employs a basketball routing algorithm. A random basketball routing (BR) is per-hop-based multi-hop routing for integrating mobility of a simple node with a routing design. In BR, a mobile node can receive and transmit the same packet many times. The BR has self-configurability in that a next transmitter (referred to as a relay node) is adaptively (or opportunistically) determined without knowing the entire network topology. The BR integrates a MAC with routing in a cross-layer optimized manner and therefore can be appropriately used for the sensor network.

Referring to FIG. 1, the wireless network according to the embodiment of the present invention includes a number of transmission nodes and relay nodes. A node for generating and transmitting its own message to other nodes is referred to as the transmission node and is also called a source node S corresponding to a destination node D. A node for receiving data between the source node S and the destination node D and which transmits the received data to other nodes is referred to as a relay node R. In a given time slot, each of nodes calculates a relay probability p (0<p<1). The relay probability is a possibility of receiving a message from a node and transmitting the message to another node. Each node listens to messages transmitted from other nodes at a possibility of p and transmits its own message to other nodes at a possibility of (1-p).

During the transmission, the node transmits its packet to a relay node or directly transmits the packet to a destination node in consideration of a distance and the like. By simply controlling the relay probability, routing in addition to the MAC in the network can be controlled. For example, if p=0, there is no packet relay, and routing is single-hop transmission in which all nodes simultaneously perform transmission. As the relay probability increases, the number of relay nodes around a transmission node increases (that is, the number of the transmission nodes decreases), and an average transmission distance and a delay due to re-transmission decrease. However, the transmission probability (1-p) of the node is also decreased, and the number of transmission opportunities decreases. As another example, if p=1, since there is no transmission node, an optimal relay probability exists, and a maximum network throughput can be obtained.

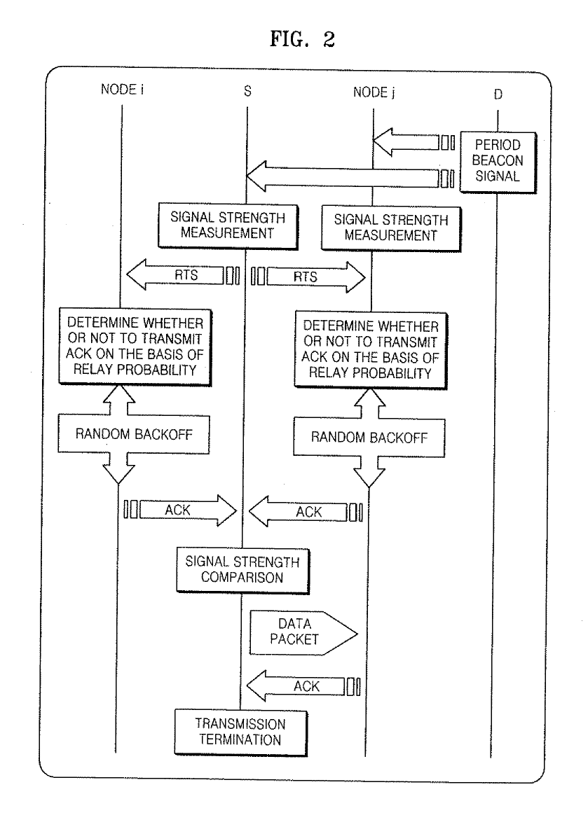

FIG. 2 is a view for explaining a message routing method of selecting a relay node in a wireless network according to another embodiment of the present invention.

Referring to FIG. 2, in the wireless network, message routing is performed between a source node S, a destination node D, and neighboring nodes i and j.

First, the destination node D periodically broadcasts a beacon signal.

Each of the nodes that receive the beacon signal, that is, the source node S and the nodes i and j, measures and stores strength of the beacon signal, so that all nodes in the wireless network perceive a position of the destination node. In addition, each node calculates and determines its relay probability p.

When the source node S is to transmit a message, the source node S transmits a request-to-send (RTS) signal to the neighboring nodes i and j in a radio range. An RTS frame header includes an identification ID of the source node S that transmits the RTS signal.

Each of the neighboring nodes i and j that receive the RTS signal determines whether or not to transmit an acknowledgement (ACK) on the basis of the relay probability p and transmits an ACK signal after waiting for a short random backoff time slots to avoid a collision. An ACK packet header includes the measured strength of the received beacon signal and an ID.

The source node S receives the ACK signals from the neighboring nodes i and j, compares the strengths of the beacon signal included in the ACK signals, and determines a node that transmits the strongest beacon signal as the relay node. The source node S transmits a data packet to the selected relay node j and terminates transmission after receiving the ACK signal from the relay node j.

If the relay node j that receives the data packet is not a destination node, the relay node j repeats operations performed by the aforementioned source node S.

As described above, transmitting a message through the relay nodes is referred to as multi-hop routing, and in this case, a probability of a message transmission success and the number of needed hops can be calculated by using the relay probability.

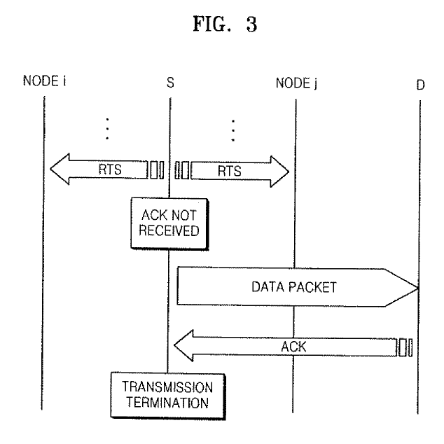

FIG. 3 is a view for explaining a method of directly transmitting a packet to a destination node when a source node does not receive ACK signals from neighboring nodes that have received an RTS signal according to another embodiment of the present invention.

Referring to FIG. 3, in a wireless network, message routing is performed between a source node S, a destination node D, and neighboring nodes i and j.

When the source node S does not receive ACK signals from the neighboring nodes i and j that have received an RTS signal transmitted from the source node S, the source node S directly transmits a packet to be transmitted to the destination node D.

Here, the source node S does not expect the packet to be transmitted to the destination node D without fail, and only when receiving an ACK signal from the destination node D, the source node S terminates transmission.

In this case, a probability of the message transmission success may be calculated by using a relay probability.

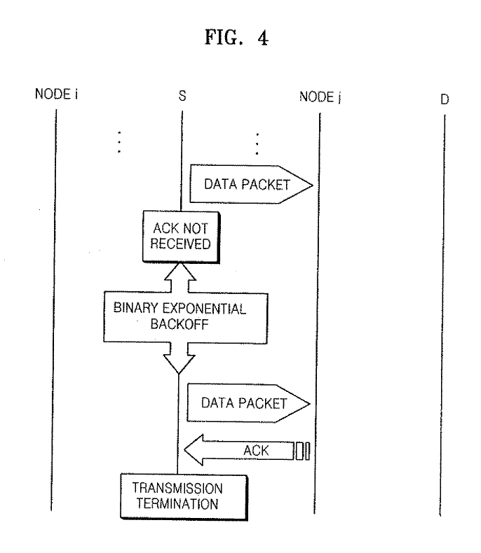

FIG. 4 is a view for explaining a method of re-transmitting a packet when a source node does not receive an ACK signal from a destination node after transmitting a packet (referred to as a message) to the destination node according to another embodiment of the present invention.

In order for the source node S to succeed in transmitting the packet to a relay node or the destination node, a reception signal-to-interference ratio (SIR) at a reception node (the relay node or the destination node) has to be a target SIR or higher.

Referring to FIG. 4, when the source node S does not receive an ACK signal although the source node S directly transmits the packet to the relay node or the destination node, it means that message transmission is not complete. Therefore, through a binary exponential backoff (BEB) scheme, the message or the packet is re-transmitted. The BEB scheme uses three parameters including a backoff stage, a backoff counter, and a contention window. In the BEB scheme, when a collision occurs, the backoff stage is increased by 1, and the contention window that is a range for selecting the backoff counter is increased twice, so that a possibility of a collision occurrence between transmission packets can be reduced. The packet re-transmission occurs individually from the transmission probability (1-p) after waiting for random backoff time slots.

The source node S terminates the transmission after receiving the ACK.

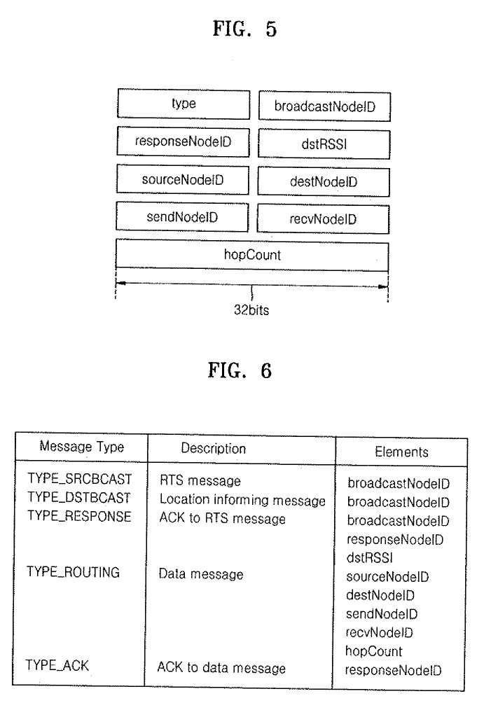

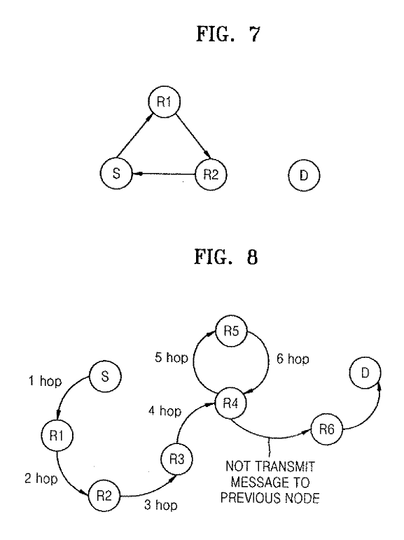

FIG. 5 illustrates a packet structure in a wireless sensor network system applying a basketball routing algorithm according to another embodiment of the present invention. FIG. 6 illustrates a message type of FIG. 5.

Referring to FIG. 5, the packet according to the present invention includes a type of a message, identification information broadcastNodeID on a broadcast node, identification information responseNodeID on a response node, a message received signal strength indication (RSSI) dstRSSI of a destination node, identification information sourceNodeID on a transmission node (referred to as a message generator), identification information destNodeID on a destination node (referred to as a message receiver), identification information sendNodeID on a current relay node that is a current forwarder, identification information recvNodeID on a next relay node that is a next forwarder, and a hopcount representing an order of the relay. Each field of the packet is allocated with 16 bits, and only the hopcount field is allocated with 32 bits.

Referring to FIG. 6, messages in the wireless sensor network system according to the present invention include an RTS message, a location informing message, an ACK message for the RTS message, a data message, and an ACK message for the data.

Each of the RTS message and the location informing message includes identification information broadcastNodeID on a broadcast node. The ACK message for the RTS message includes identification information on a broadcast node (broadcastNodeID), identification information on a response node (responseNodeID), and a message of a destination node (RSSI dstRSSI). The data message includes identification information on a transmission node (sourceNodeID), identification information on a destination node (destNodeID), identification information on a current relay node (sendNodeID), identification information on a next relay node (recvNodeID), and a hopcount. The ACK message for the data includes identification information on a response node (responseNodeID).

For example, when power is supplied to a sensor node, node listens to channels to receive a packet. A destination node periodically broadcasts a TYPE_DSTBCAST message to inform other nodes of a position of the destination node. Each node that receives the TYPE_DSTBCAST message measures and stores an RSSI as a dstRSSI. A source node broadcasts a TYPE_SRCBCAST message in order to select a next relay node. Each of neighboring nodes determines whether or not to transmit a TYPE_RESPONSE message on the basis of its relay probability after receiving the TYPE_SRCBCAST message. Next, the transmission node compares its dstRSSI with a dstRSSI contained in the received TYPE_SRCBCAST message. When the dstRSSI of the source node is largest, the source node directly transmits a TYPE_ROUTING message to the destination node. Otherwise, the source node transmits a TYPE_ROUTING message by using a node having the largest dstRSSI value as the relay node. The relay node that receives the TYPE_ROUTING message transmits a TYPE ACK message to the source node and checks whether or not a destNodeID is the same as a local address of the relay node. If the destNodeID is the same as the local address, routing is terminated, and otherwise, the relay node broadcasts a TYPE_SRCBCAST message and the aforementioned operations are repeated.

In a case where a message is transmitted through relay nodes or directly transmitted to a destination node, if a transmission node does not receive an ACK signal, it means that message transmission is not complete, so that the message or data can be re-transmitted through the BEB scheme.

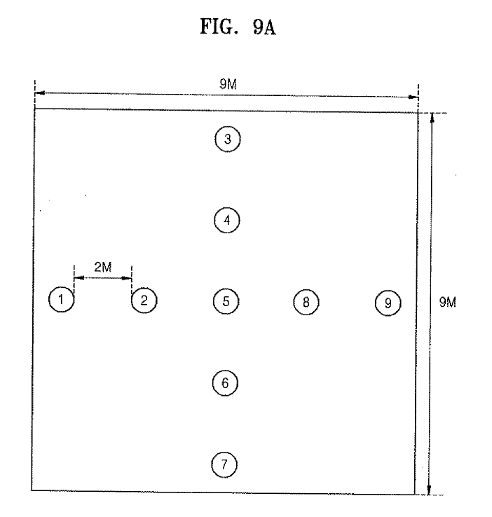

FIG. 7 illustrates a message loop that may occur when a message is transmitted using relay nodes according to another embodiment of the present invention.

Referring to FIG. 7, the message cannot be transmitted to a destination node D and is repeatedly transmitted only between specific nodes S, R1, and R2, which is referred to as a “message loop”. The message loop may occur in a static environment. This is because in the message transmission method according to the present invention, relaying the same packet to a single node one or more times is allowed.

In order to prevent the message loop, according to the present invention, the hopcount representing the number of hops through which a message is transmitted is used.

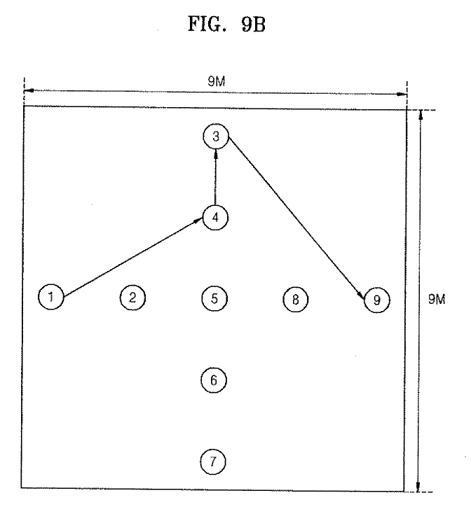

FIG. 8 is a view for explaining a method of preventing a message loop according to another embodiment of the present invention.

In order to prevent a case where a message is transmitted only between specific nodes and cannot be transmitted to a destination node, a loop-free mechanism is used. In the loop free mechanism, a loop threshold is set in advance, and if hop count exceeds the loop threshold at a current relay node, a relay node does not transmit a received message to a node that has transmitted the same message to the relay node. By applying the loop-free mechanism, the message can be transmitted to the destination node.

Referring to FIG. 8, a message transmitted from a source node S reaches a 6 hop that exceeds a 5 hop that is a loop threshold, a corresponding node R₄ does not transmit the message to nodes R₃ and R₅ which transmitted the message to the node R4, that is, nodes having a hopcount of 1 or more, but transmits the message to another node R₆ so as to allow the message to be transmitted to the destination node D.

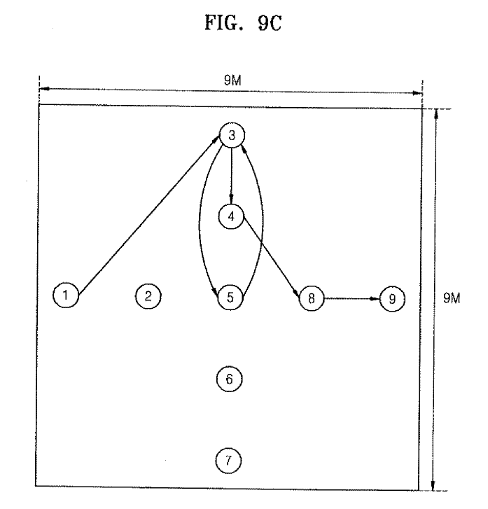

FIGS. 9A to 9D are views for representing a topology of a network system according to another embodiment of the present invention.

Referring to FIG. 9A, sensor nodes are cruciformly arranged. When a minimum path routing scheme is employed to transmit a message from a first node that is farthest to the left to a ninth node, the message is always transmitted in order of first, second, fifth, eighth, and ninth nodes. It means that advantages of the wireless network cannot be applied, loads are concentrated only on the first, second, fifth, eighth, and ninth nodes, and remaining nodes cannot perform message transmission.

Referring to FIGS. 9B and 9C, in a sensor network applying the present invention, relay nodes are determined according to relay probabilities, so that nodes such as third and fourth nodes can perform the message transmission. In addition, referring to FIG. 9D, in the sensor network applying the present invention, a message can be transmitted to destination node without some relay nodes, so that advantages such as a decrease in the number of hops, a decrease in wait time, improved load distribution, and the like can be obtained.

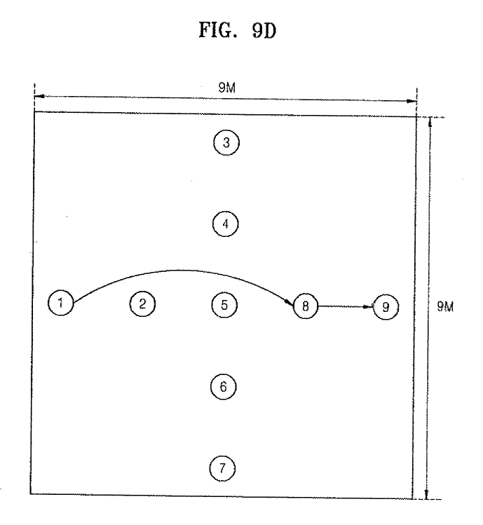

FIG. 10 is a flowchart for explaining a method of updating a relay probability according to another embodiment of the present invention.

Since the sensor network system according to the present invention supports mobility of a sensor node, sensor nodes may come into the network system to be included therein or move out of the network system to be excluded therefrom. In this case, by updating a relay probability of each node, a message transmission performance of the sensor network can be dynamically optimized.

Referring to FIG. 10, when a transmission node that is to transmit a message receives an ACK message for an RTS message, the transmission node counts the number of received ACK messages (operation S1010). The ACK message counting may be periodically set according to a network design or performed only at a predetermined time.

The number of ACK messages (Rᵢ^{k+1}) is compared with the number of previous ACK messages (Rᵢ^{k}), and it is determined whether or not the numbers are equal (operation S1030).

When the numbers are different, it is determined that decrease or increase in the number of sensor nodes in the network occurs, and each of the sensor nodes updates a relay probability of the sensor node by using the following equation (operation S1050). When the relay probability is updated, a kth value is substituted by a (k+1)th value, and operations S1010 to S1030 are periodically repeated. A relay probability updated at a node i is calculated by using a ratio of the number of previous sensor nodes to the number of current sensor nodes (that is, a ratio of numbers of ACK messages received before and after the updating).

$${P}_{i}^{k - 1} = min \{ max \{ {P}_{min} , \frac{{R}_{i}^{( k + 1 )}}{{R}_{i}^{k}} {P}_{i}^{k} \} , {P}_{max} \} \qquad ( 1 )$$

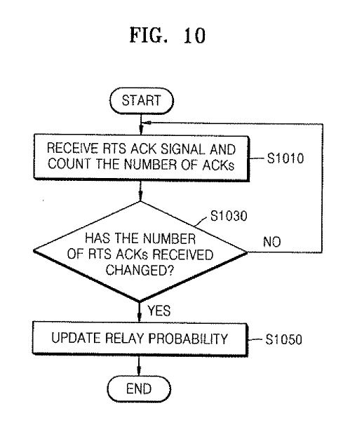

FIG. 11 is a graph illustrating the number of hops with respect to the number of nodes.

Referring to FIG. 11, the number of hops required to transmit a packet from a source node to a destination node in a first case i where the present invention is applied is compared with the number of hops in a second case ii where carrier sense multiple access with collision avoidance (CSMA/CA) based ad-hoc on-demand distance vector (AODV) routing is applied.

According to the current embodiment, five to fifteen nodes are disposed in a space of 2.05M×14M, a source node and a destination node are disposed at both ends, and relay nodes are disposed therebetween. A transmission coverage of each node is set to 6M, an optimal relay probability p is set to 0.83, a response wait time RESPONSE_WAIT_TIME is set to 5 s, an ACK wait time ACK WAIT TIME is set to 2 s, a request-to-send message transmission time BCAST_TIME is set to 10 s, and a loop threshold is set to 10 hop.

As shown in the graphs, when the present invention is applied, the number of hops required is smaller than that in the AODV routing, and it can be seen that a performance according to the present invention is improved as compared with the AODV routing as the number of nodes in the network is increased.

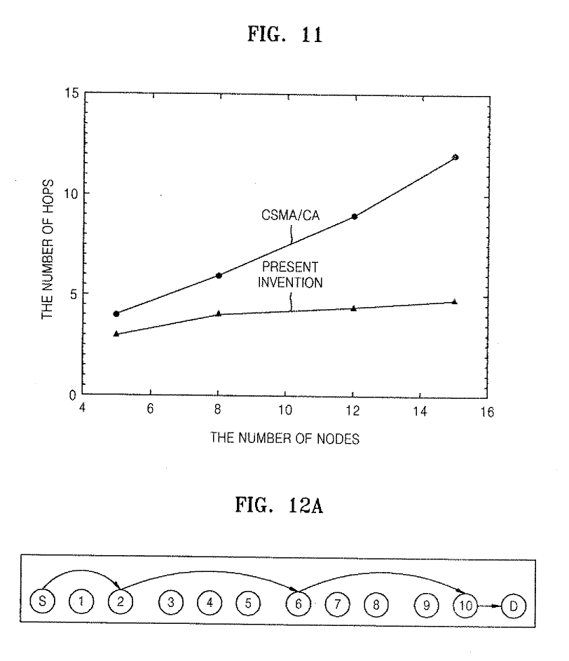

For example, as illustrated in FIG. 12A, in the wireless network including twelve nodes applying the present invention, due to opportunistic nature of the wireless network, skipping nearby nodes is possible, and a message can be transmitted from a source node to a destination node through four hops. However, as illustrated in FIG. 12B, when the CSMA/CA based AODV routing is applied, a message is relayed through nine hops, that is, almost all nodes. Therefore, the network applying the present invention can distribute and decrease loads.

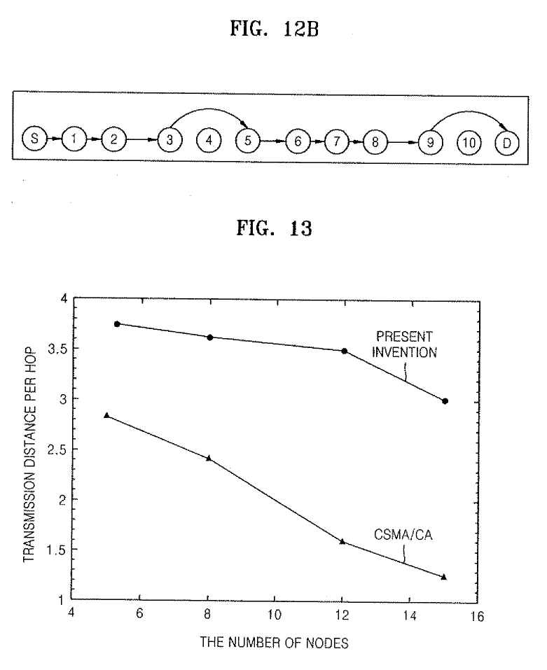

FIG. 13 is a graph showing transmission distance per hop with respect to the number of nodes, the parameters thereof being the same as those in FIG. 11.

Referring to FIG. 13, as the number of nodes increases, both transmission distance per hop when the present invention is applied and transmission distance per hop when the CSMA/CA based AODV routing is applied decrease, however, a longer transmission distance can be used when the present invention is applied. Therefore, the number of hops can be decreased.

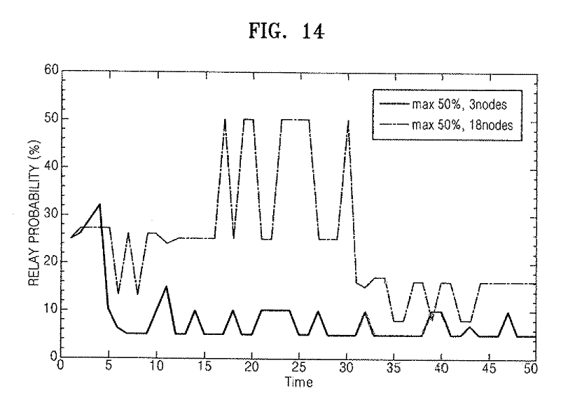

FIG. 14 is a graph showing a result of a test that was performed by using a method of updating a relay probability according to an embodiment of the present invention, and setting an initial value of the relay probability as being 25% and a variation range of the relay probability as being 5˜50%.

Referring to FIG. 14, a dotted line indicates a case when eighteen nodes were used and thus a node density is high, and a solid line indicates a case when three nodes were used and thus the node density is low. A horizontal axis is a temporal axis and corresponds to a kth value of an update algorithm to which Equation 1 is applied, and a vertical axis corresponds to a relay probability value. It is clear that the relay probability has a small value as the node density is high and has a large value as the relay probability is low.

According to the present invention, a message routing method based on relay probability is applied. Therefore, throughput per node can be improved, and a wireless network in which a message can be transmitted without a MAC layer can be configured.

In addition, message transmission loads can be distributed and decreased in the wireless network according to the present invention.

The invention can also be embodied as computer readable codes on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, and carrier waves (such as data transmission through the Internet). The computer readable recording medium can also be distributed over network coupled computer systems so that the computer readable code is stored and executed in a distributed fashion. Also, functional programs, codes, and code segments for accomplishing the present invention can be easily construed by programmers skilled in the art to which the present invention pertains.

While the present invention has been particularly shown and described with reference to exemplary embodiments thereof, it will be understood by those skilled in the art that various changes in form and details may be made therein without departing from the spirit and scope of the invention as defined by the appended claims. The exemplary embodiments should be considered in descriptive sense only and not for purposes of limitation. Therefore, the scope of the invention is defined not by the detailed description of the invention but by the appended claims, and all differences within the scope will be construed as being included in the present invention.

What is claimed is:

1. A wireless sensor network comprising:
a destination node broadcasting a beacon signal to nodes in a network;
a transmission node transmitting a request-to-send message to neighboring nodes to select a relay node that relays a message to be transmitted to the destination node, receiving acknowledgement messages from the neighboring nodes which determine whether to transmit the acknowledgement messages on the basis of relay probabilities, and selecting the relay node on the basis of the acknowledgement messages; and
a relay node receiving a beacon signal, measuring a strength of the beacon signal, transmitting an acknowledgement message including the strength of the beacon signal to the transmission node, and receiving the message from the transmission node.

2. The wireless sensor network of claim 1, wherein the transmission node receives the beacon signal and measures and stores the strength of the beacon signal.

3. The wireless sensor network of claim 1, wherein the message includes at least one of a type of the message, an identification number of a current relay node, and an identification number of a next relay node.

4. The wireless sensor network of claim 1, wherein the transmission node determines a neighboring node which transmits an acknowledgement message with the largest signal strength as the relay node.

5. The wireless sensor network of claim 1, wherein the transmission node counts the number of received acknowledgement messages to detect decrease or increase in the number of nodes in the network and updates relay probabilities based on the result of the counting.

6. The wireless sensor network of claim 5, wherein, when decrease or increase in the number of nodes is detected by the transmission node, each of the neighboring nodes including the relay node updates its own relay probability.

7. The wireless sensor network of claim 6, wherein the relay probability is updated on the basis of a ratio of the number of acknowledgement messages previously received and the number of acknowledgement messages currently received, corresponding to a ratio of the number of nodes previously existed and the number of the nodes currently existed in the network.

8. A method of controlling a wireless sensor network comprising:
a transmission node transmitting a request-to-send message to neighboring nodes in the network;
each of the neighboring nodes determining whether or not to transmit an acknowledgement message on the basis of its own reliability and transmitting the acknowledgement message to the transmission node;
the transmission node determining a node that is to relay data to be transmitted to the destination node from among the neighboring nodes that transmit the acknowledgement messages;
the transmission node counting the number of the acknowledgement messages and determining a decrease or increase in the number of nodes in the network; and
each of the transmission node and the neighboring nodes updating its own relay probability on the basis of the decrease or increase in the number of the nodes.

9. The method of claim 8, wherein the relay probability is updated on the basis of a ratio of the number of acknowledgement messages previously received and the number of acknowledgement messages currently received, corresponding to a ratio of the number of nodes previously existed and the number of the nodes currently existed in the network.
